(19) United States
(12) Patent Application Publication
(10) Pub. No.: US 2004/0184645 A1
(43) Pub. Date: Sep. 23, 2004

(54) Method and apparatus for viewing images

(76) Inventor: Serge Muller, Guyancourt (FR)

Correspondence Address: CANTOR COLBURN, LLP, 55 GRIFFIN ROAD SOUTH, BLOOMFIELD, CT, 06002

(21) Appl. No.: 10/756,630

(22) Filed: Jan. 13, 2004

(30) Foreign Application Priority Data
Jan. 14, 2003 (FR) 03 00339

(51) Int. Cl. G06K 9/00

(52) U.S. Cl. 382/128

(57) ABSTRACT

A method and apparatus for viewing radiological images having an imaging device commanded to acquire images at a given frequency and to transmit them to a processor. The processor reconstitute, based on several images acquired by the imaging device, intermediate images. A display successively displays the acquired images and the intermediate images, the intermediate images being placed between the acquired images so that the frequency at which the display renews the displayed image is greater than the acquisition frequency of the imaging device.

### CROSS-REFERENCE TO RELATED APPLICATIONS

This application claims the benefit of a priority under 35 USC 119 (a)-(d) to French Patent Application No. 03 00339 filed Jan. 14, 2003, the entire contents of which are hereby incorporated by reference.

### BACKGROUND OF THE INVENTION

An embodiment of the invention is directed to a method and apparatus for viewing images of an object and, in particular, viewing images in the field of medical imaging.

In surgical radiology, the operations carried out by a surgeon or other medical practitioner are carried out using images provided by a source of radiation, such as fluoroscopy. For this purpose, the patient may already have been injected with a tracing liquid or a contrast enhancement prior to or during the operation. As a result of this technique, the surgeon or other medical practitioner can view an image of the internal structures of the zone of the patient to be treated on a screen in real time. During the operation, the surgeon or other medical practitioner uses this image to direct the instruments in these structures and to check the progress of the operation. The result is that the surgical radiology permits operations to be performed that are only very slightly invasive.

This technique requires the operating theatre to be equipped with a radiological imaging device. The device classically comprises a means for providing radiation, such as an X ray source, and means for providing an image, such as an image detector, positioned opposite the source. The anatomical part of the patient being treated is positioned between the source and the detector. The beam emitted by the source passes through the patient's internal biological structures before reaching the detector. This beam is partially absorbed by the internal structure such that the intensity of the beam received by the detector is attenuated. The images acquired by the detector are therefore the result of a projection of the anatomical part of the patient in the plane of the detector.

These images are acquired at a given rate, and are transmitted in real time to means for processing that control the display of these images on a means for display, such as a screen in the operating theatre. The surgeon or other medical practitioner can view on the screen both the internal structures of the patient to be treated and the position of the instrument(s) in relation to these structures. The surgeon or other medical practitioner then guides the instrument(s) by referring to the images as viewed.

It is desirable to reduce the rate of these images acquired by the imaging detector, in order that the dose of radiation administered to the patient is minimized. Consequently, this reduction increases the refresh times of the screen. This results in a low display frequency that can be a particular problem for the surgeon or medical practitioner in certain cases, as the surgeon or medical practitioner may view the progress of the operation in jerky images that can be detrimental to the visual control of the movements of the surgeon or medical practitioner. Furthermore, a low display frequency can also cause tiredness in a short space of time.

### BRIEF DESCRIPTION OF THE INVENTION

An embodiment of the invention is directed to the viewing conditions of the progress of the operation. An embodiment of the invention is a method and apparatus for viewing images comprising: means for imaging is commanded to acquire the images at a given frequency and to transmit them to means for processing; the means for processing reconstitutes intermediate images, based on several images acquired from the means for imaging; means for display successively displays the images acquired and the intermediate images, the intermediate images being placed between the acquired images, so that the frequency at which the means for display renews the displayed image is greater than the acquisition frequency of the means for imaging.

In an embodiment of the invention, the intermediate images produced by the means for processing allow a transition to be formed between the acquired images. Consequently, the progress of the operation appears on the means for display means as if it was continuous.

In an embodiment of the invention the method permits the effective display frequency to be increased without increasing the image acquisition rate of the means for imaging.

In an embodiment of the invention, the intermediate images are calculated as a combination of images acquired by the means for imaging. For example, the pixel intensities of the intermediate images are calculated as a combination of the pixel intensity values of the acquired images. This combination may comprise an extrapolation or an interpolation of the acquired images.

In an embodiment of the invention, the intermediate images are calculated by an estimation of the movement.

### BRIEF DESCRIPTION OF THE DRAWING

Other characteristics and advantages will be better understood from the following description, which is given purely by way of illustration and is in no way restrictive and should be read with reference to the appended drawings, wherein:

FIG. 1 shows schematically an apparatus for viewing images corresponding to an embodiment of the invention;

FIG. 2 is a block diagram showing the steps in an embodiment of a method for viewing images;

### DETAILED DESCRIPTION OF THE INVENTION

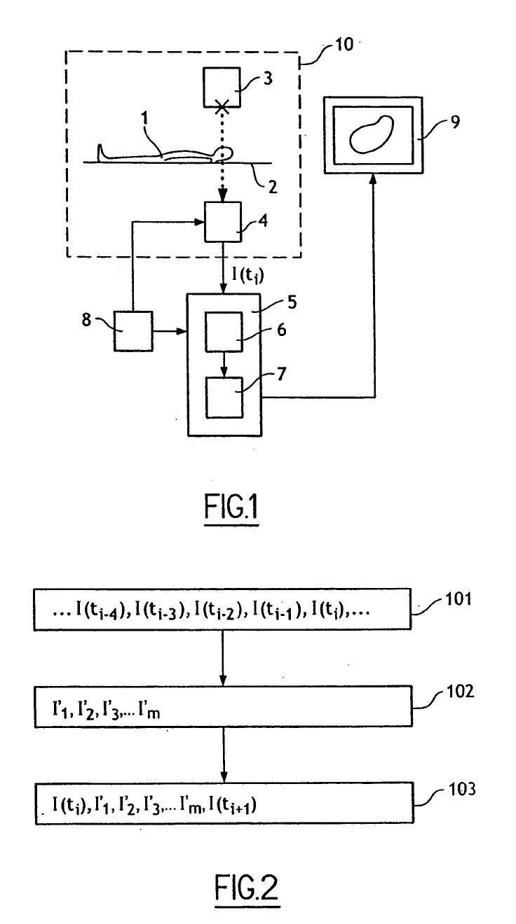

In FIG. 1, a patient 1 who is to undergo an operation is placed on an operating table 2 between an X ray source 3 and an opto-electronic detector 4 of a means for imaging 10. The source 3 emits radiant energy at a frequency of around 10 Hz. The detector 4 and the source 3 are synchronised so that the detector acquires approximately 10 images per second.

The detector 4 transmits the data relative to the images acquired in real time to means for processing 5, in the form of a processor. The processor 5 has a buffer memory 6 in which it saves the data and a microprocessor 7 that allows this data to be processed. The means for imaging device 10 and the means for processing 5 are synchronised by a clock 8. The processor 5 commands means for display 9 in the form of a screen placed in the operating theatre so that it displays the images acquired by the means for imaging 10.

The processor 5 is capable of reconstituting intermediate images, from several images acquired by the means for imaging. The processor 5 transmits these intermediate images to the display screen 9 so that it successively displays the acquired images and the intermediate images, the intermediate images being placed between the acquired images.

FIG. 2 represents the method applied by the processor 5 of FIG. 1, to determine the intermediate images from the images acquired by the means for imaging 10. This method can be applied continuously on the data transmitted by the means for imaging.

In step 101, the processor 5 receives at a given instant t₁ a set of data I(t₁) corresponding to an image acquired by the image detector 4. This data I(t₁) is, for example, a set of intensity values associated to the image detector pixels. The processor 5 stores the data in its buffer memory 6 as it receives it.

In step 102, the processor 5 determines the intermediate images from the data stored I(t₁), I(t₂), I(t₃), . . . I(tₙ), corresponding to the images acquired by the means for imaging.

Assuming that the image acquisition frequency of the detector 4 is R₁ and that the frequency at which the images on the screen 9 are to be renewed is R₂ (R₂>R₁), the processor 5 produces between two successive acquired images I(t₁) and I(t₁₊₁) a number M of intermediate images: M=R₂/(R₁−1).

In an embodiment of step 102, a series of M intermediate images between a first image I(t₁) and a second image I(t₁₊₁) is calculated by extrapolation of the images I(t₁₋₃), I(t₁₋₂), I(t₁₋₁), I(t₁) of a previous series of images. Therefore the intensity of a pixel of an intermediate image I′1, I′2, . . . I′_{M} is calculated by extrapolation of the variation of the intensity of the pixels associated to the images . . . I(t₁₋₄), I(t₁₋₃), I(t₁₋₂), I(t₁₋₁), I(t₁) as a function of the time. The extrapolation will take into account the last two images I(t₁₋₁) and I(t₁) received by the processor. In this case, this extrapolation can be linear. In this assumption, the buffer memory 6 should therefore only store two images at any given time.

In an embodiment of step 102, a series of intermediate images I′1, I′2, I′_{M}, between a first image I(t₁) and a second image I(t₁₊₁) is calculated by interpolation of the images I(t₁) of a previous series of images and a following series of images. Therefore, the intensity of an intermediate image pixel is calculated by interpolation of the variation in intensity of the pixels associated to the images . . . I(t₁₋₄), I(t₁₋₃), I(t₁₋₂), I(t₁₋₁), I(t₁) as a function of the time. This interpolation may take into account the last image I(t₁) received by the processor and a following image I(t₁₊₁). In this case, this interpolation can be linear. In this assumption, the buffer memory 6 should therefore only store these two images. In this embodiment the processor 5 has to wait until it receives the data of the second image I(t₁₊₁) in order to be able to determine the intermediate images by interpolation.

In an embodiment of step 102, the processor 5 includes a program using an algorithm that estimates movement. Such algorithms are shown in the following publications: “Temporal linking of motion-based segmentation for object oriented image sequence coding”, GARCIA-GARDUNO, LABIT, BONNAUD, Signal processing 7^{th} theories and applications proceedings of EUSIPCO-94, September 1994, Edinburgh; “Multiple occluding objects tracking using a non-redundant boundary based presentation for image sequence interpolation after decoding”, BONNAUD, LABIT, Proceedings 1997 International conference on Image Processing ICIP, October 1997, Santa Barbara; “Spatio-temporal wiener filtering of image sequences using a parametric motion model”, DEKEYSER, BOUTHEMY, PEREZ, Proceedings 2000 International conference on Image Processing ICIP, September 2000, Vancouver; “Robust fast extraction of video objects combining frame differences and adaptative reference image”, CAPLIER, BONNAUD, CHASSERY, Proceedings 2001, International conference on Image Processing ICIP, October 2001, Thessaloniki. These programs allow the images to be segmented into different parts, some parts represent fixed structures and other parts represent moving structures. They are generally based on a subtraction of images between images. This subtraction cancels the pixels that are identical from one image to the next and highlights the pixels whose intensity varies.

For example, in the case where the internal structures that are imaged are fixed and the surgeon or medical practitioner introduces an instrument into these structures (catheter or other), only the pixels that represent the instrument will be modified from one image to the next and they will constantly evolve. Furthermore, the trajectory of the instrument is predictable for certain operations. For example, in the case of a trans-cutaneous puncture, the trajectory of the catheter is practically linear. In this case, the processor 5 will reconstitute the intermediate images by duplicating the pixels that represent the internal structures imaged and modify them by extrapolation or interpolation of the pixels representing the surgical instrument.

In step 103, the processor 5 commands the screen 9 so that it successively displays the acquired images I(t₁₋₁), I(t₁₊₁) and the intermediate images I′1, I′2, . . . I′M, that it has processed, the intermediate images being placed between the acquired images.

In the case of the processor 5 determining the intermediate images by extrapolation, it transmits the image I(t₁) acquired by the detector to the screen. The processor 5 then calculates and transmits to the screen intermediate images I′1, I′2, . . . I′M, until it receives the following image I(t₁₊₁).

In the case of the processor 5 carrying out an interpolation, the processor may only transmits an acquired image I(t₁) to the screen when it receives the following image I(t₁₊₁). The reception of the following image I(t₁₊₁) triggers the processing and the transmission of the intermediate images I′1, I′2, . . . I′_{M} to the screen. The result is that the screen display is not instantaneous. The screen display may be delayed by a time approximately equal to the time interval between two successive acquisitions of the detector.

The described embodiments permit the surgeon or other medical practitioner to view the images of the anatomical structure being treated with a frequency of renewal of the images similar to those of audio-visual (e.g. 24 images per second).

One skilled in the art may propose or make various modifications to the structure/way and/or function and/or way and/or steps of the disclosed embodiments and equivalents thereof without departing from the scope and extant of the invention.

What is claimed is:

1. A method for viewing images comprising:
commanding means for imaging device to acquire images at a given frequency and to transmit the images to means for processing;
the means for processing reconstitute, based on several images acquired by the means for imaging, intermediate images;
successively displaying on means for display the acquired images and the intermediate images, the intermediate images being placed between the acquired images so that the frequency at which the means for display renews the displayed image is greater than the acquisition frequency of the means for imaging.

2. The method of claim 1 wherein the intermediate images are calculated as a combination of images acquired by the means for imaging.

3. The method of claim 2 wherein the intermediate images are obtained by extrapolation of the images acquired by the means for imaging.

4. The method of claim 3 wherein the extrapolation is linear and may take into account only the last two images acquired.

5. The method of claim 2 wherein the intermediate images are obtained by interpolation of the images acquired by the means for imaging.

6. The method of claim 5 wherein the interpolation is linear and may take into account only the last two images acquired.

7. The method of claim 1 wherein the intermediate images are calculated by estimation of movement, the immobile zones of the acquired images being duplicated to reconstitute the intermediate images.

8. An apparatus for viewing images comprising:
means for acquiring images;
means for processing the acquired images;
means for displaying the images;
wherein the means for processing is capable of applying the method of claim 1.

9. The apparatus of claim 8 wherein the means for processing comprises:
a buffer memory capable of storing data supplied by the means for imaging and defining the acquired images;
the buffer memory having sufficient capacity to store a number of images required for the means for processing to determine a series of consecutive intermediate images.

10. The apparatus of claim 8 comprises a clock for synchronizing the means for imaging and the means for processing.

11. The apparatus of claim 9 comprises a clock for synchronizing the means for imaging and the means for processing.

13. A computer program comprising code means that when executed on a computer having a means for processing carry out the steps of claim 1.

14. A computer program on a carrier carrying code that when executed on a computer having means for processing carry out the steps claim 1.
